(19) United States
(12) Patent Application Publication
(10) Pub. No.: US 2005/0240429 A1
(43) Pub. Date: Oct. 27, 2005

(54) Method for assembling, organizing, disseminating and managing information relating to real estate transactions

(76) Inventors: Andrew Dieden, Mill Valley, CA (US); Jamal Noorzoy, Pebble Beach, CA (US)

Correspondence Address: VIERRA MAGEN MARCUS HARMON & DENIRO LLP, 685 MARKET STREET, SUITE 540, SAN FRANCISCO, CA, 94105, US

(21) Appl. No.: 11/112,891

(22) Filed: Apr. 22, 2005

Related U.S. Application Data
(60) Provisional application No. 60/564,568, filed on Apr. 22, 2004.

(51) Int. Cl. G06F 17/60

(52) U.S. Cl. 705/1

(57) ABSTRACT

Software for assembling, organizing, disseminating and managing information relating to real estate transactions.

### CROSS REFERENCE TO RELATED APPLICATION

The present invention claims priority to U.S. Provisional Patent Application Ser. No. 60/564,568, entitled, “Method For Assembling, Organizing, Disseminating And Managing Information Relating To Real Estate Transactions,” filed Apr. 22, 2004, which application is incorporated by reference herein in its entirety.

### COPYRIGHT NOTICE

The following patent disclosure includes material that is subject to copyright protection. The copyright owner has no objection to the facsimile reproduction of the disclosure by any person as it appears in the records of the U.S. Patent and Trademark Office, but otherwise reserves all rights to the copyright whatsoever.

### BACKGROUND OF THE INVENTION

1. Field of the Invention

The present invention relates to software relating to real estate transactions, and in particular, to software for assembling, organizing, disseminating and managing information relating to real estate transactions.

2. Description of Related Art

Whether buying, selling or financing, real estate transactions require the assimilation and organization of vast amounts of information. Moreover, owing to the strict legal requirements for contracts relating to the sale of land, real estate transactions require the generation of an enormous amount of written documents. There are property information documents, disclosure documents and inspection reports, title reports, appraisals, financing, sales and escrow documents, and listing agent information to name a few. Gathering, organizing and keeping track of this information has conventionally been an extremely daunting task. Moreover, as real estate transactions generally take months to complete, information changes over time. Updating written documents to reflect the latest information further exacerbates the problem of managing transactional information.

With the evolution of the World Wide Web, information may now be easily, quickly and widely disseminated in a variety of multimedia formats. However, while conventional websites exist for providing information to would-be buyers about available properties, there are relatively few tools available to assist sellers of real estate and/or their agents in gathering, organizing, presenting and managing information relating to real estate transactions.

### BRIEF DESCRIPTION OF THE DRAWINGS

The invention will now be described with reference to the figures, in which:

FIG. 1 is a block diagram of computers, servers and a network over which the software according to the present invention may be used.

FIG. 2 is a main options screen presented by the software according to the present invention;

FIG. 3 is a property information screen presented by the software according to the present invention;

FIG. 3A is a screen showing the property listings for which profiles have been created;

FIG. 4 is an information and document setup screen presented by the software according to the present invention;

FIG. 5 is a listing agent information screen presented by the software according to the present invention;

FIG. 6 is a slide show screen presented by the software according to the present invention;

FIG. 7 is a virtual tour screen presented by the software according to the present invention;

FIG. 8 is a floor plan screen presented by the software according to the present invention;

FIG. 9 is a company information screen presented by the software according to the present invention;

FIG. 10 is a flyer screen presented by the software according to the present invention;

FIG. 11 is a title report screen presented by the software according to the present invention;

FIG. 12 is an inspection report screen presented by the software according to the present invention;

FIG. 13 is an appraisal screen presented by the software according to the present invention;

FIG. 14 is a disclosure document screen presented by the software according to the present invention;

FIG. 15 is a listing sales and escrow screen presented by the software according to the present invention;

FIG. 16 is a community information screen presented by the software according to the present invention;

FIG. 17 is a miscellaneous documents screen presented by the software according to the present invention;

FIG. 18 is a home owners association screen presented by the software according to the present invention;

FIG. 19 is a custom document screen presented by the software according to the present invention;

FIG. 20 is an information and document setup screen presented by the software according to the present invention including information for the completed listing profile;

FIG. 21 is a screen from a listing profile generated by the software according to the present invention;

FIG. 22 is a screen presented by the software according to the present invention providing the option to create a compact disk of the listing information; and

FIG. 23 is a screen presented by the software according to the present invention providing the option to email listing information.

### DETAILED DESCRIPTION

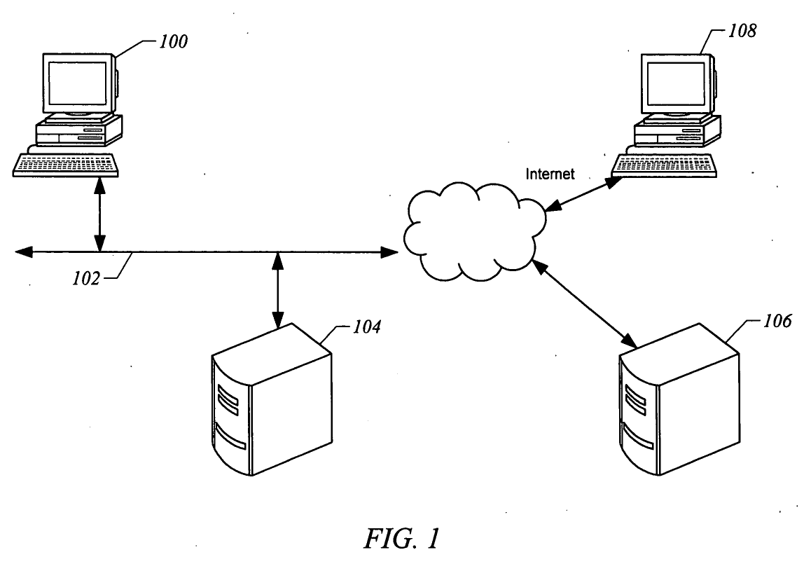

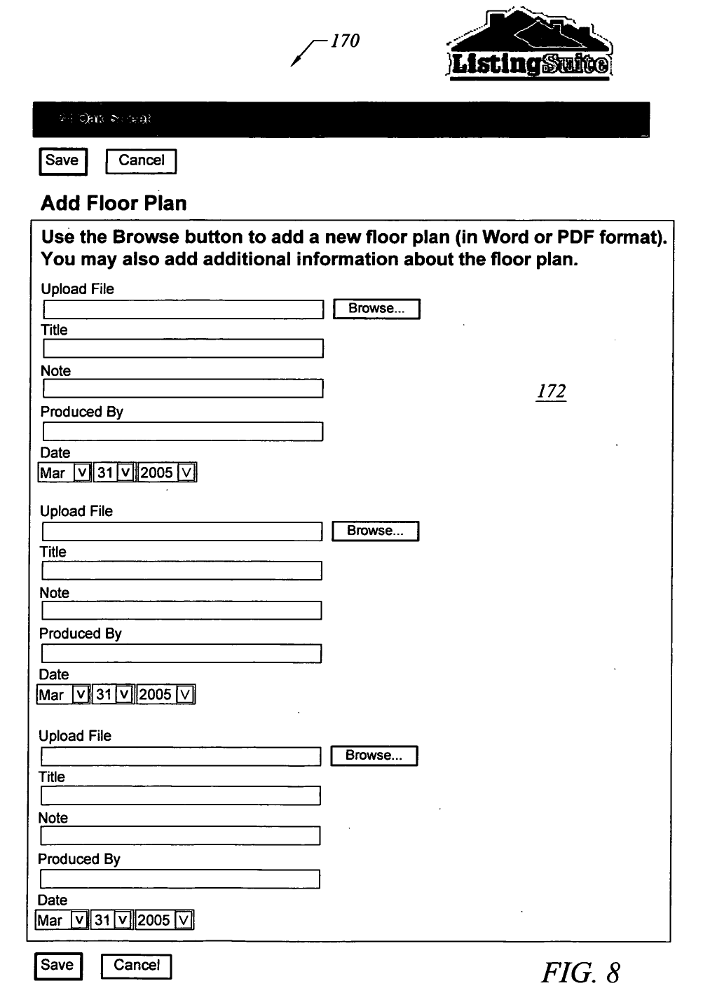

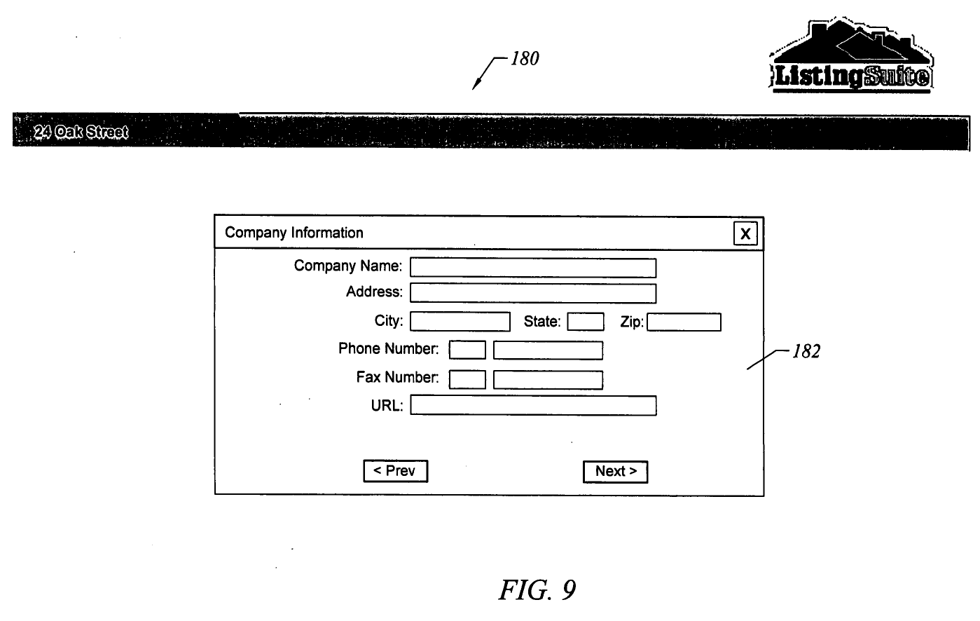

The invention will now be described with reference to FIGS. 1-23, which in preferred embodiments relate to a method for assembling, organizing, disseminating and managing information. In embodiments of the present invention, the information relates to real estate transactions. However, as explained hereinafter, it is understood the software according to the present invention may be used to assemble, organize, disseminate, and manage information in fields other than real estate.

It is understood that the present invention may be embodied in many different forms and should not be construed as being limited to the embodiments set forth herein; rather these embodiments are provided so that this disclosure will be thorough and complete and will fully convey the invention to those skilled in the art. Indeed, the invention is intended to cover alternatives, modifications and equivalents of these embodiments, which will be included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details. In other instances, well known methods, procedures and components have not been described in detail as not to unnecessarily obscure aspects of the present invention.

Referring now to FIG. 1, software according to the present invention may be loaded on and executed from a computer 100, which may form part of a network 102. The network may be a LAN, WAN or connected to the Internet (as shown). The software according to the present invention may be loaded onto computer 100 from a portable memory medium or downloaded over a network 102 via the Internet. Once loaded onto computer 100, the software may be installed with the aid of a Windows setup wizard guiding the user through the installation process and allowing the user to personalize the software with his or her identification. As would be appreciated by those of skill in the art, the software according to the present invention may be rendered in a compiled language, such as for example, Visual Basic, C, C++, C#, Visual C#.net, etc. One embodiment of the source code according to the present invention is attached hereto in Exhibit A.

In general, the software according to the present invention performs three operations relating to a transaction for the sale of real estate. The first operation is information acquisition. The software presents the user with a series of templates prompting the user to enter information relating to all relevant aspects of the user's real estate transaction. Once the user enters all relevant information, the software then performs an organization operation where the information is organized into a “listing profile.” A listing profile is a formatted software presentation including all relevant aspects relating to the real estate as determined by the user's input. The listing profile is generated by the software according to the present invention using XML (extensible markup language) and/or XSL (extensible style sheet language). Other database and markup languages are contemplated.

Once generated, the listing profile may be stored on a server 104. In embodiments of the present invention, the user may be a real estate agent. In such embodiments the network 102 may be a secure LAN within the agent's company. In alternative embodiments, the user may be the owner of the real estate to be sold. In such embodiments, once the listing profile is generated on the user's computer 100, the listing profile may be stored on server 106 to which the user subscribes. In a further embodiment, a user of a computer 100 may have no software according to the present invention stored locally. However, the user of computer 100 may access the server 106 via the Internet, and generate a listing profile using the software stored on server 106 (or a computer networked to computer 106). The listing profile data files may thereafter be stored on the server 106, or on server 104 forming part of the user's local intranet.

The software according to the present invention further provides for the quick and easy dissemination of the listing profile. Once the listing profile is stored using XML and/or XSL, the listing profile may be viewed using a variety of platforms, typically for example, using conventional browsers such as Internet Explorer or Netscape. Thus, interested parties may view the listing profile over the internet from remote computers 108. As will be explained hereinafter, the listing profile may also be recorded onto a medium such as a compact disc, and sent through the mail.

Information Acquisition

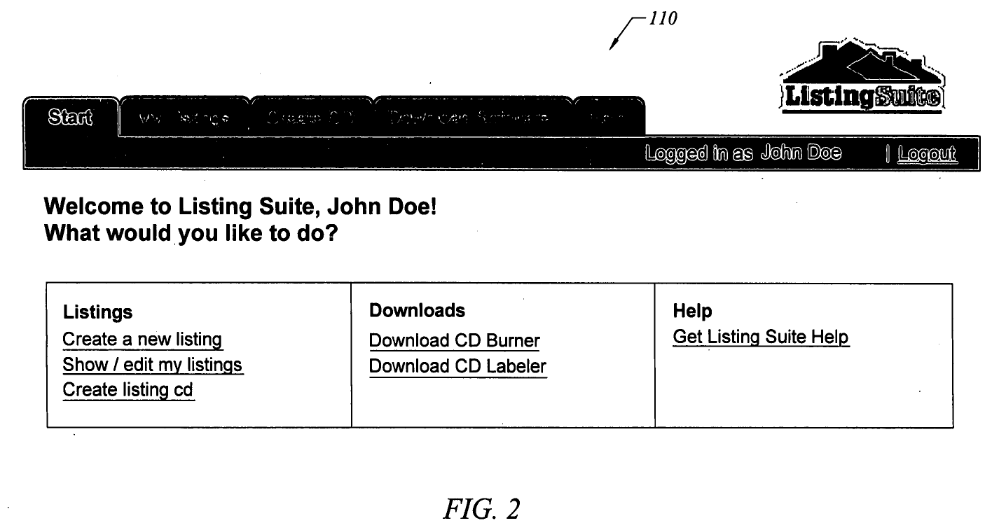

Referring now to FIG. 2, the software according to the present invention initially presents the user with a main option screen 110, customized with the identification information entered by the user, such as for example the user's name. The main options screen presents the user with a template having several options. In embodiments of the invention, these options include:
Create new listing profile
Work with previously saved listing profile
Create a listing profile compact disc and print a listing profile label
Download compact disc burner and/or labeler
Logout and/or exit this listing profile session
Help, which accesses help files either stored locally upon installation of the software according to the present invention or downloaded over network 102.

The user may access any of these options by clicking on the options. It is understood that additional options beyond those shown may be provided on main option screen 110 in alternative embodiments. And it is understood that the options may be selected by means other than clicking on the options (such as for example by presenting the user with check boxes).

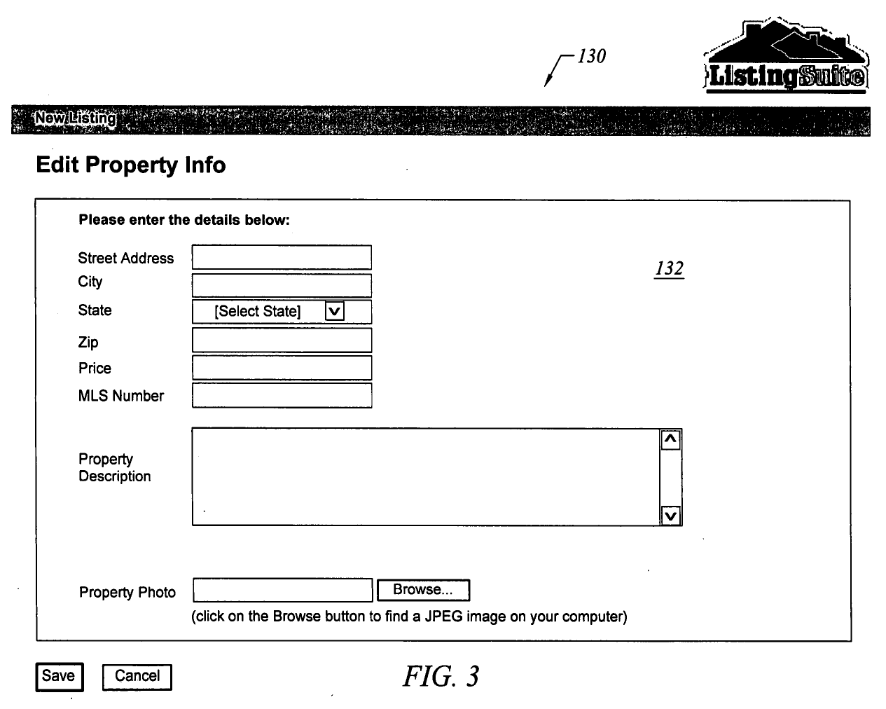

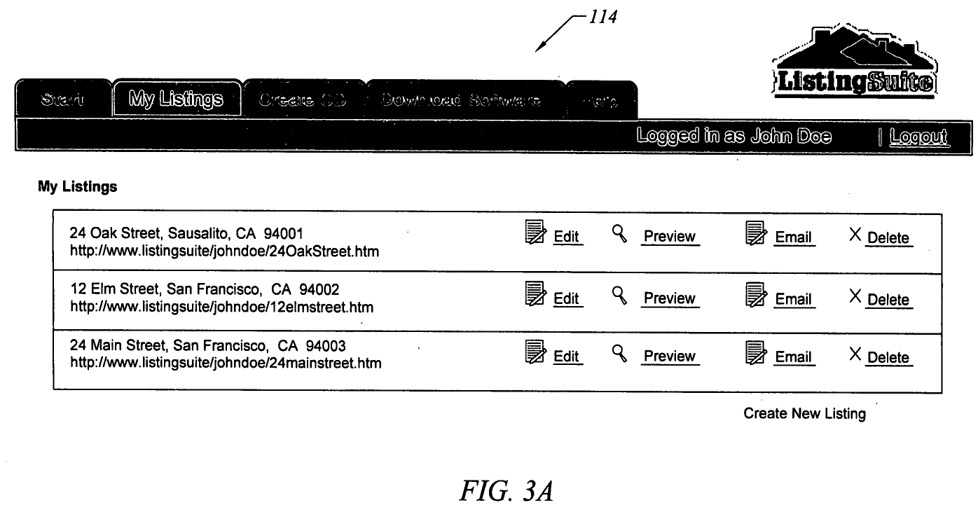

Clicking on the “create new listing” option brings up a property information screen 130 (FIG. 3) which presents a template 132 allowing a user to add information regarding a property to be listed or edit information regarding a previously created listing profile. Information regarding a listing may include the location, price, an associated reference number (e.g., MLS Number) referencing the property as shown on another website, a description of the property and/or a picture of the property. The user may add a photo stored locally on a user's computer 100 or otherwise downloaded over network 102. The software according to the present invention may request more or less information than that set forth above and shown in FIG. 3. This information is stored on server 104.

As shown in FIG. 3A, the software according to the present invention may store information regarding multiple properties. A screen 114 may be presented to a user showing the various properties for which listings have been created. A user can select a particular property from among a plurality of properties, and then perform a variety of operations on the listing, such as for example editing the listing, previewing the finished listing profile, email the listing profile or delete the listing.

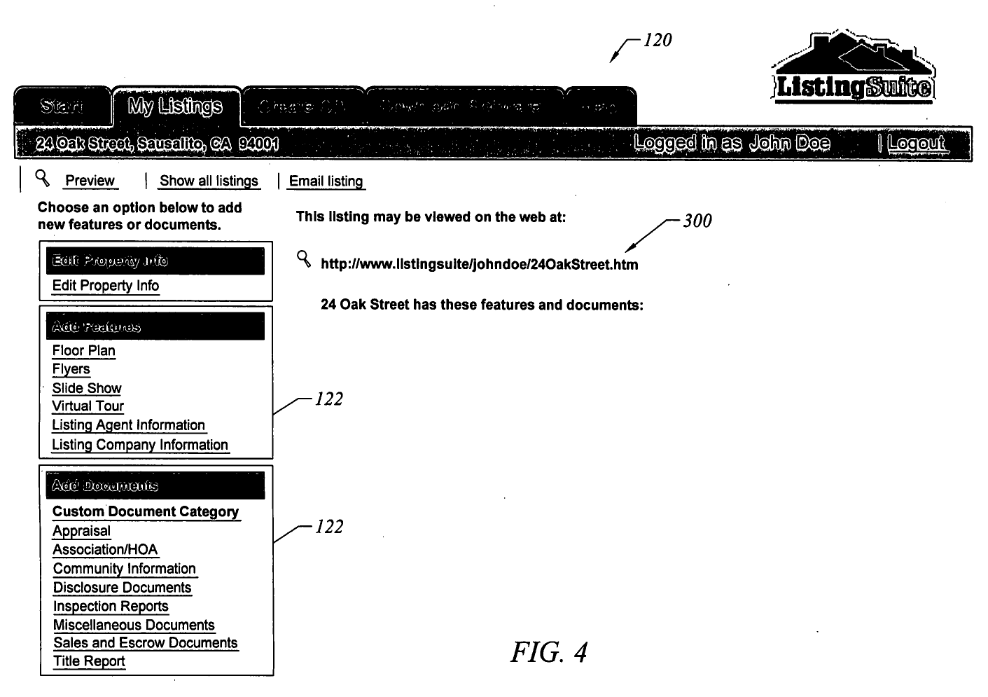

Once a property listing profile has been created, the user may be given the option to associate information and documents with that property listing. An information and document setup screen 120 is provided for this purpose as shown in FIG. 4. The setup screen 120 presents the user with a template 122 having a plurality of options for the user to add information and documents to the listing profile. If the user desires to add information with regard to a particular topic or document, the user selects that topic or document from the template, and the user is presented with additional screens to add the additional information and/or documents as explained hereinafter. Once all the desired information and documents to be included in the listing profile have been designated, the software according to the present invention will then give the user the option to add the information with respect to all checked topics and documents as explained hereinafter.

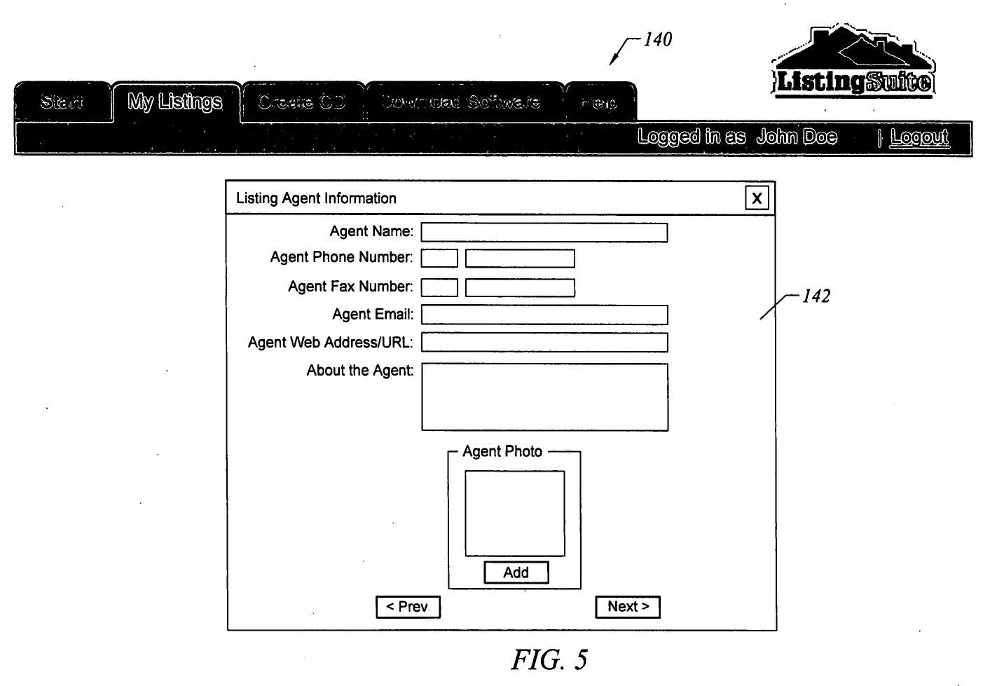

Either as part of template 122 or before setup screen 120 is presented to the user (i.e., during initialization of the software), the software according to the present invention may present a screen 140 (FIG. 5) having a template 142 allowing the user to add listing agent information. As indicated above, in embodiments of the present invention, the user of the software may be the listing agent. For such embodiments, the agent's name may be added using template 142. It is understood, however, in alternative embodiments, the software according to the present invention may also be used by the seller of the house, in which case the user's identification may be different than the agent's name, and the user may include the agent's name on the listing agent information template 142 of screen 140. Screen 140 further allows the user to enter additional information regarding the listing agent, such as for example, phone and fax numbers, email address, website, biographical information and a photo of the agent downloaded from the user's computer 100 or from the Internet.

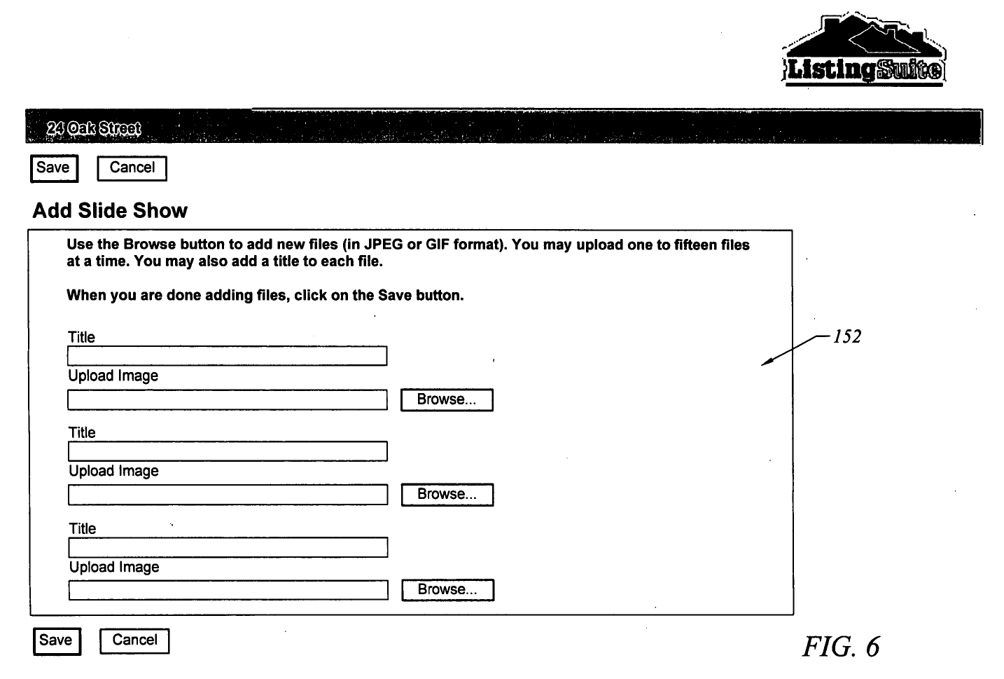

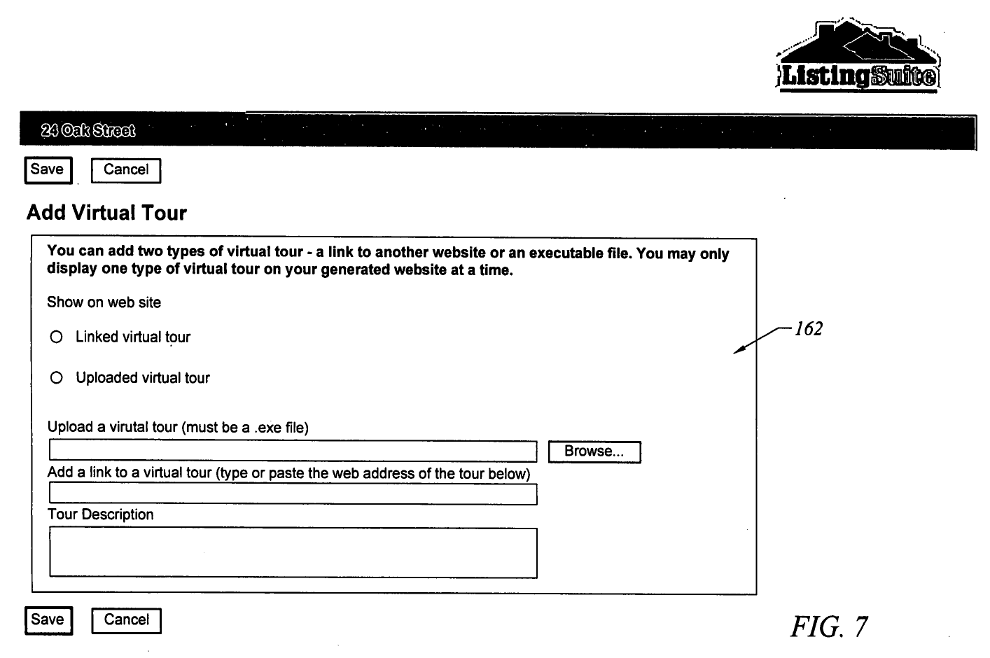

If the user indicates from setup screen 120 that he or she wishes to include one or more pictorial slide shows or a virtual tour, the user is given these options in templates 152 and 162 presented by the software according shown in FIGS. 6 and 7, respectively. FIG. 6 shows a template 152 where a user may add and delete one or more images stored on the user's computer 100 or downloaded over network 102. The images may be in any known graphics format, such as for example, jpeg, gif, tif or Adobe pdf. FIG. 7 shows a template 162 presented by the software according to the present invention, which gives the user an option to add video such as a virtual tour known in the art. The video may be of any known file format, such as mpeg or avi. The template 162 may further give the user the options to add notes explaining or relating to the video.

If the user indicated a desire to add one or more floor plans on setup screen 120, the user is further provided with a screen 170 including a template 172 allowing the user to add a graphics file showing the floor plan of the property for sale. The user is also provided with the ability to add notes explaining or relating to the floor plan.

If the user indicated a desire on setup screen 120 to include company information, the user is further provided with a screen 180 having a template 182 allowing the user to add additional contact information for the real estate agent.

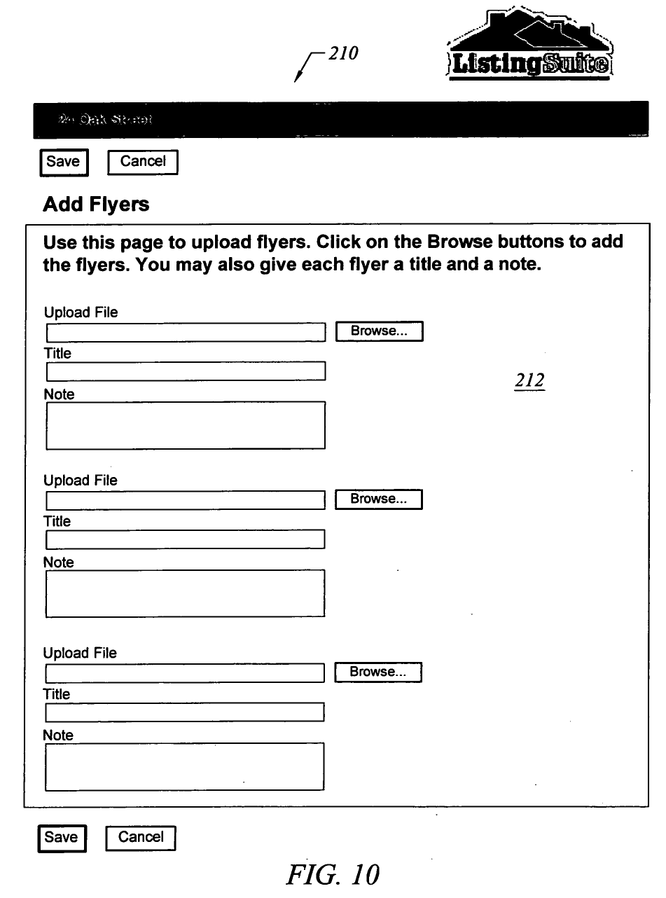

If a user indicated a desire to include flyers relating to the real estate, the user is presented with a screen 210 having a template 212 as shown in FIG. 10 presenting the user with a template allowing the user to add one or more flyers. The user may be given the option to generate these flyers at the main option screen 110 shown in FIG. 2 via a link to existing software applications, such as for example Microsoft Office Presentations. The user may also be given the option to add a title for an uploaded file, as well as adding notes relating to an uploaded file.

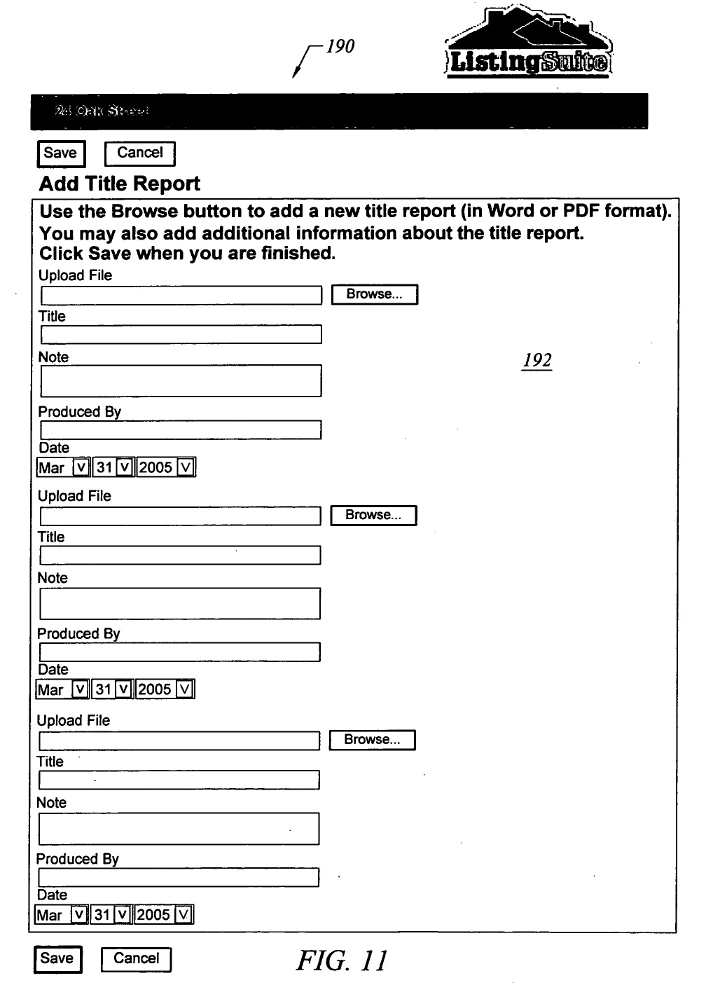

The template shown on the setup screen 120 (FIG. 4) further allows the user to include electronically stored copies of a variety of documents. If the user indicated a desire to include one or more title reports, the user is given that option in the template 192 as shown on screen 190 in FIG. 11. The template shown on screen 190 additionally allows the user to include information relating to who produced the report, the date the report was generated, and any additional notes relating to the report. The user may also be given the option to add a title for an uploaded file, as well as adding notes relating to an uploaded file.

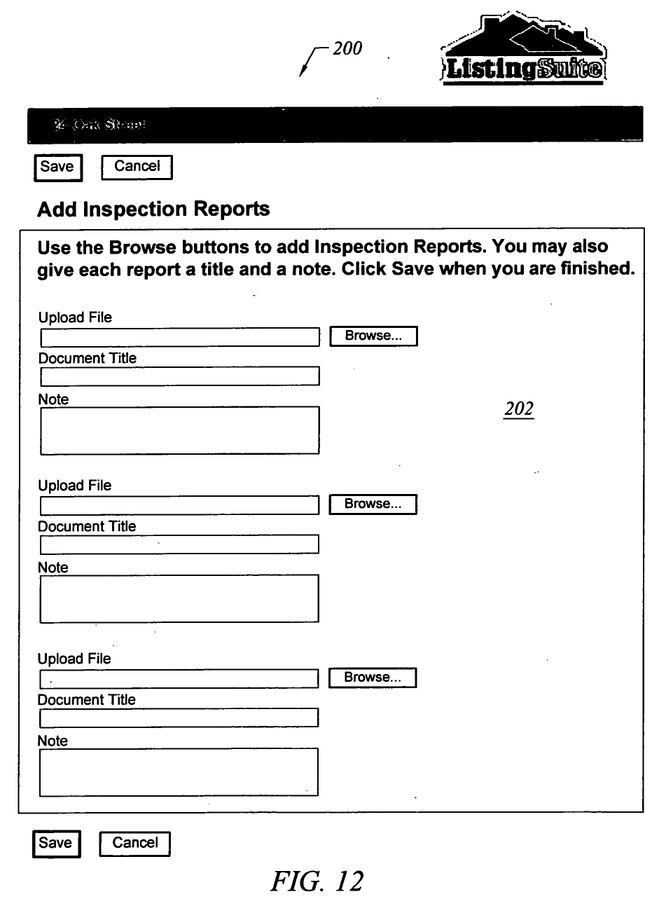

If the user indicated a desire to include one or more inspection reports by selecting the appropriate option on the template 122 shown in FIG. 4, the user is presented with a screen 200 as shown in FIG. 12. The screen 200 presents the user with a template 202 allowing the user to add inspection reports relating to the real estate, as well as notes relating to the inspection reports. The user may also be given the option to add a title for an uploaded file, as well as adding notes relating to an uploaded file.

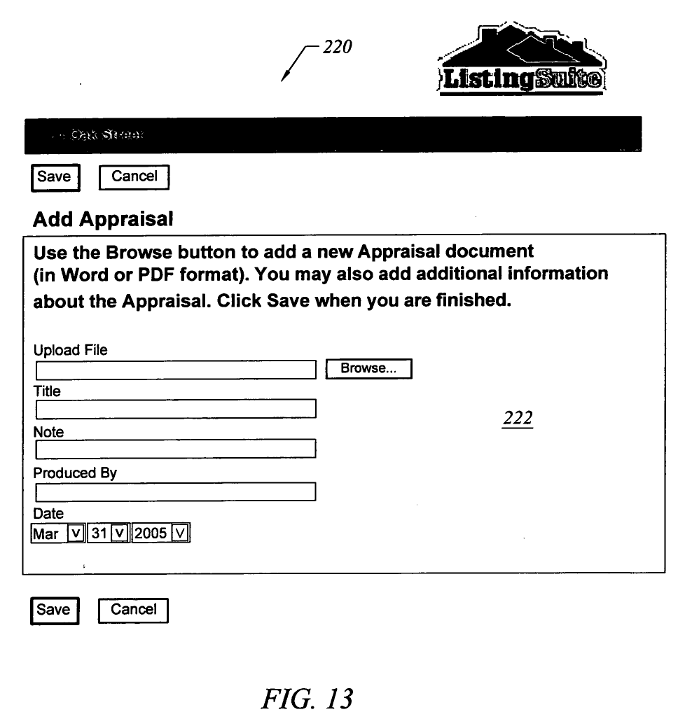

If the user indicated a desire to include an appraisal of the real estate by selecting the appropriate option on the template 122 shown in FIG. 4, the user is presented with a screen 220 as shown in FIG. 13. The screen 220 presents the user with a template 222 allowing the user to add an appraisal reports relating to the real estate, as well as other information relating to the appraisal, such as who performed the appraisal, date of the appraisal and notes relating to the appraisal. The user may also be given the option to add a title for an uploaded file, as well as adding notes relating to an uploaded file.

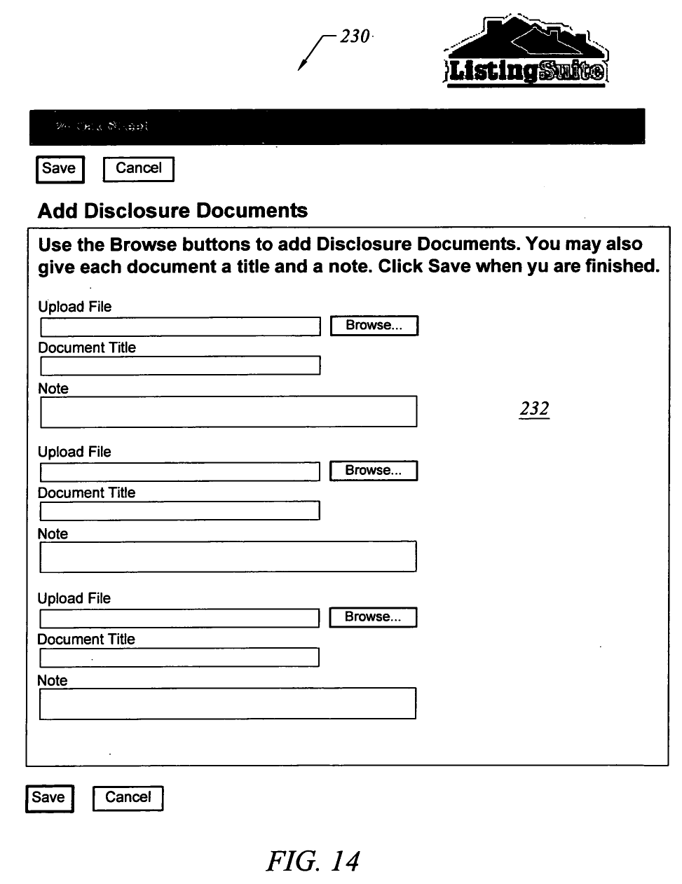

If the user indicated a desire to include disclosure documents by selecting the appropriate option on the template 122 shown in FIG. 4, the user is presented with a screen 230 as shown in FIG. 14. The screen 230 presents the user with a template 232 allowing the user to add disclosure documents relating to the real estate. The user may also be given the option to add a title for an uploaded file, as well as adding notes relating to an uploaded file.

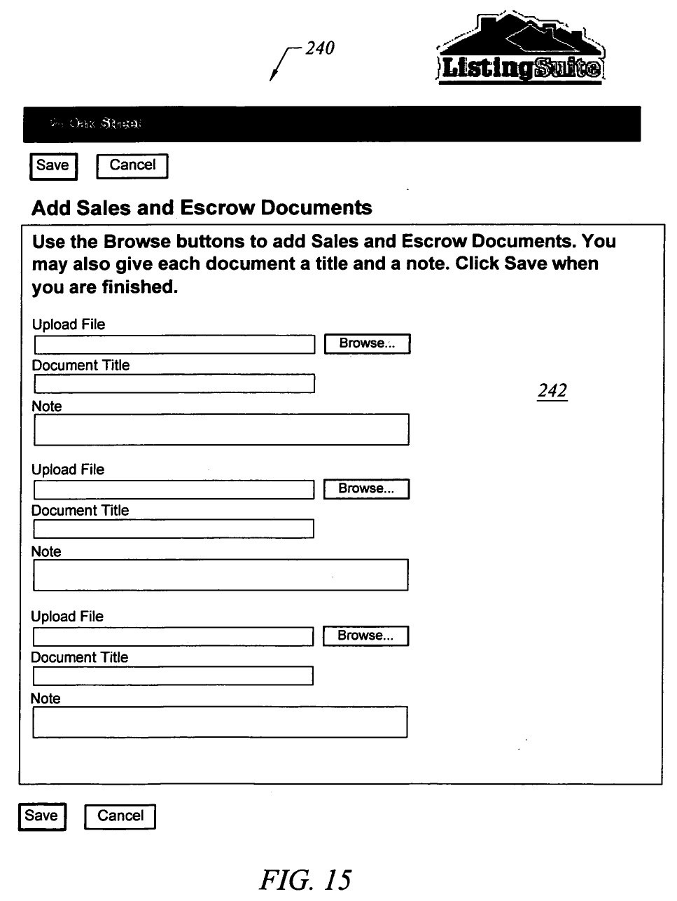

If the user indicated a desire to include one or more sales and escrow documents by selecting the appropriate option on the template 122 shown in FIG. 4, the user is presented with a screen 240 as shown in FIG. 15. The screen 240 presents the user with a template 242 allowing the user to add sales and escrow documents relating to the real estate. The user may also be given the option to add a title for an uploaded file, as well as adding notes relating to an uploaded file.

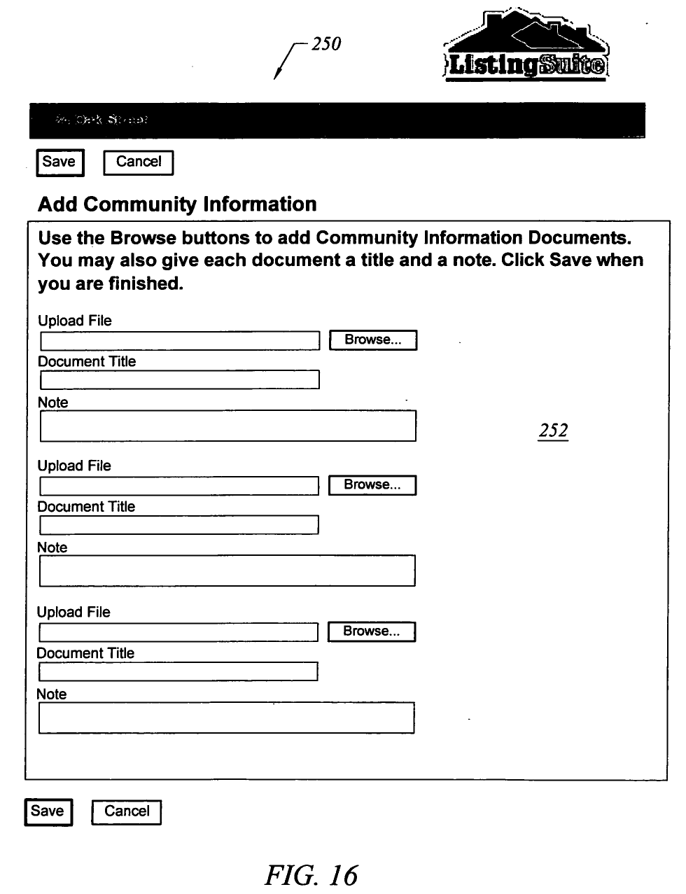

If the user indicated a desire to include one or more files relating to community information by selecting the appropriate option on the template 122 shown in FIG. 4, the user is presented with a screen 250 as shown in FIG. 16. The screen 250 presents the user with a template 252 allowing the user to add community information for the community where the real estate is located. The user may also be given the option to add a title for an uploaded file, as well as adding notes relating to an uploaded file.

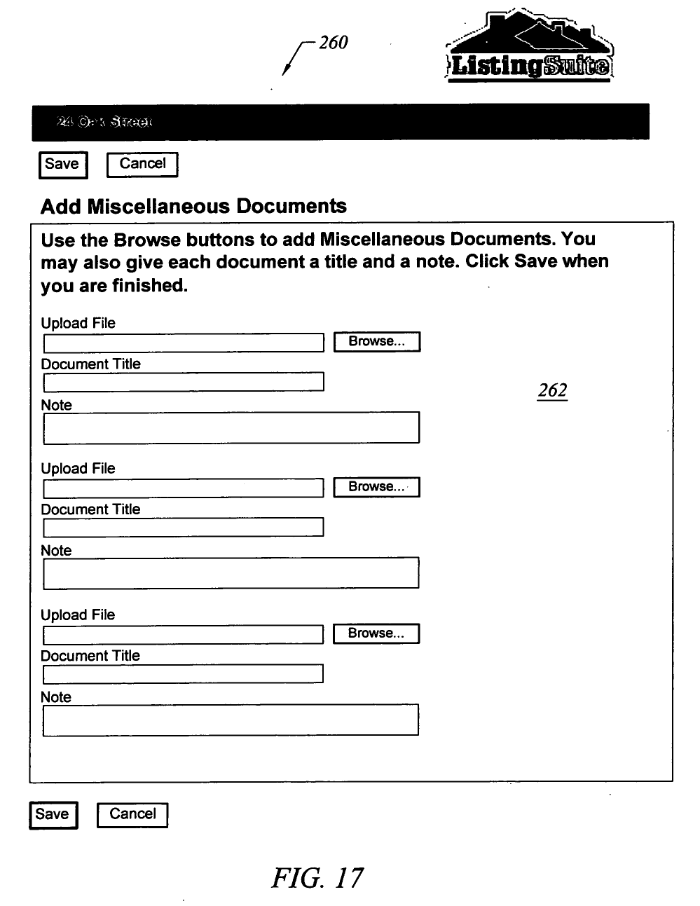

If the user indicated a desire to include miscellaneous documents by selecting the appropriate option on the template 122 shown in FIG. 4, the user is presented with a screen 260 as shown in FIG. 17. The screen 260 presents the user with a template 262 allowing the user to add miscellaneous documents relating to the real estate. The user may also be given the option to add a title for an uploaded file, as well as adding notes relating to an uploaded file.

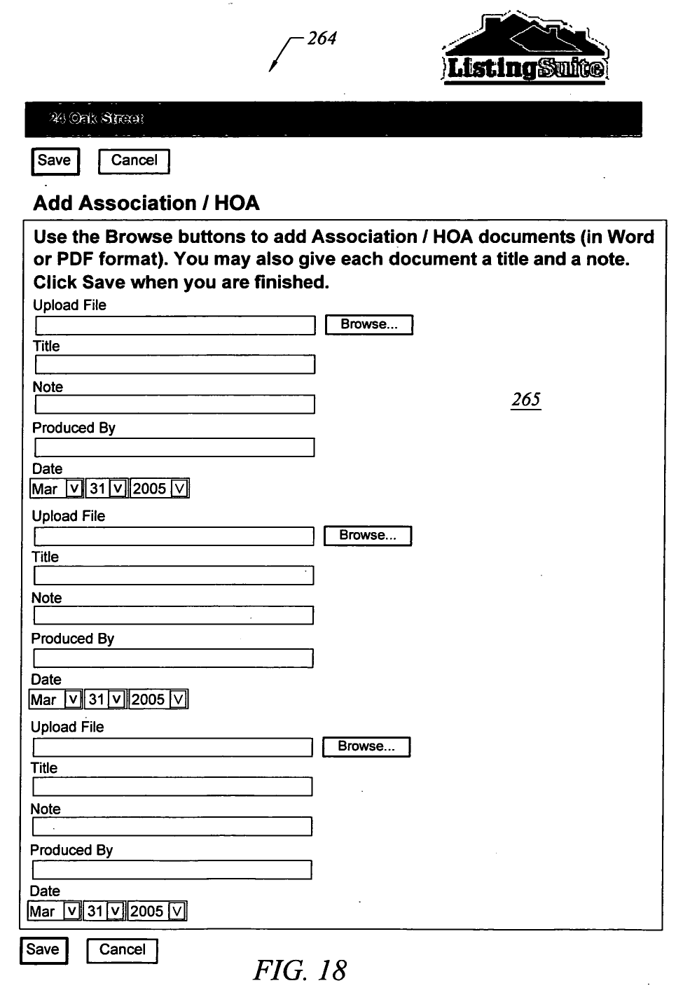

If the user indicated a desire to include one or more files relating to home owner or other associations related to the property by selecting the appropriate option on the template 122 shown in FIG. 4, the user is presented with a screen 264 as shown in FIG. 18. The screen 264 presents the user with a template 265 allowing the user to add files including information relating to home owner or other associations. The user may also be given the option to add a title for an uploaded file, as well as adding notes relating to an uploaded file.

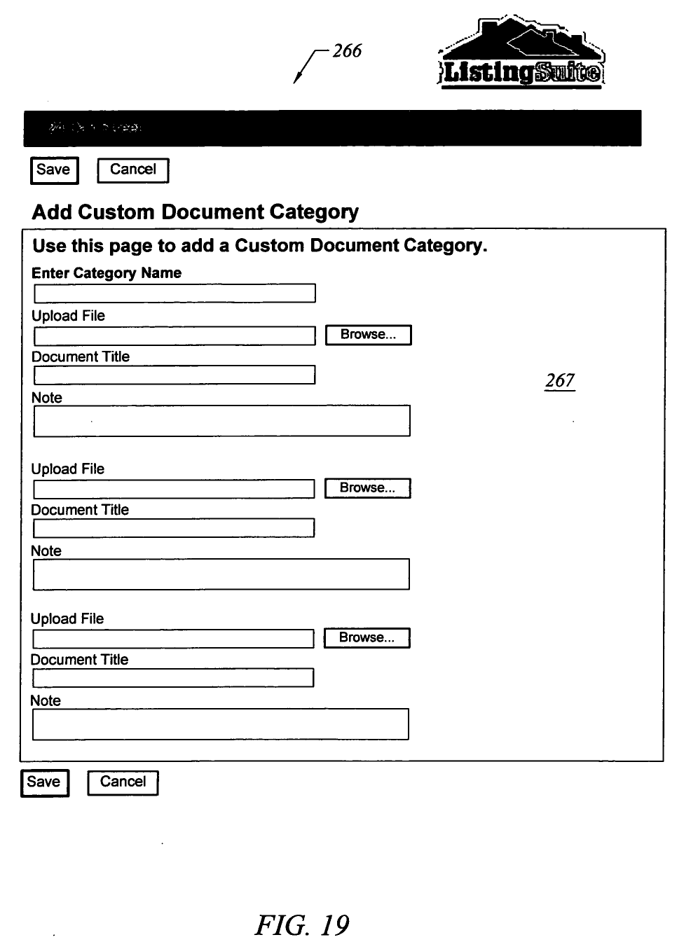

If the user indicated a desire to include one or more files relating to a customized document category by selecting the appropriate option on the template 122 shown in FIG. 4, the user is presented with a screen 266 as shown in FIG. 19. The screen 266 presents the user with a template 267 allowing the user to define additional categories, and then add files relating to that category. The user may also be given the option to add a title for an uploaded file, as well as adding notes relating to an uploaded file.

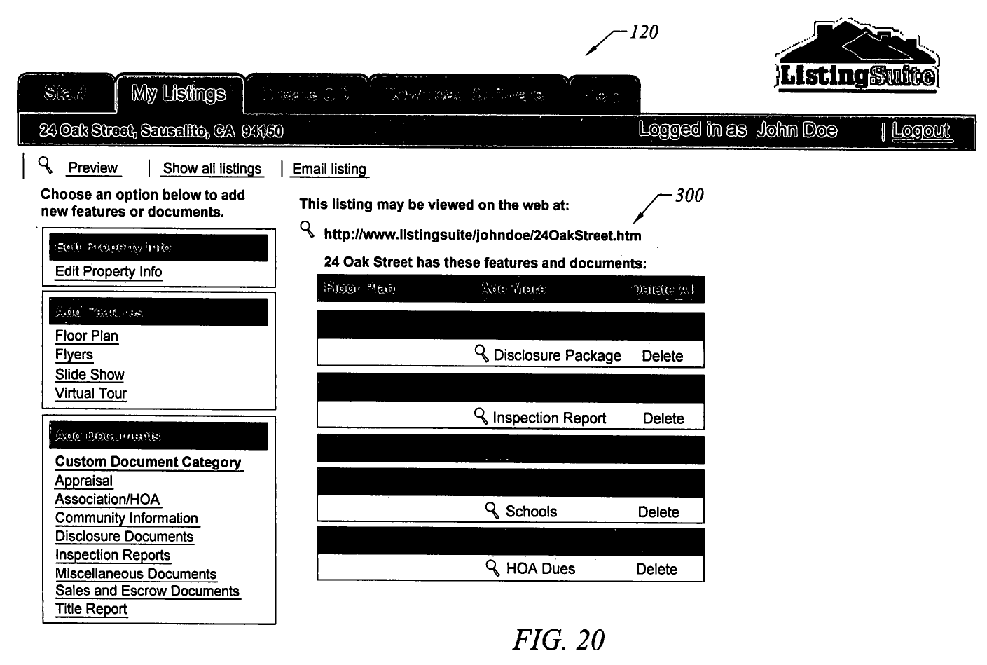

It is understood that fewer than all of the options presented in the template 122 in FIG. 4 may be selected by the user. It is understood that the information and document setup screen 120 (FIG. 4) may be omitted and that all option screens may be presented to the user in alternative embodiments. The user is free to move forward and back between the various templates shown on FIGS. 5 through 19 using navigation buttons provided on each screen. In embodiments, each time information or documents are added to a listing, the screen 120 (FIG. 4) may be updated to show the new information and/or documents. For example, where a user has navigated the screens described above, and added a disclosure package, an inspection report, and documents relating to schools and home owner association dues, screen 120 may be updated as shown in FIG. 20.

Information Organization

As information is gathered for the listing profile using the above-described screens, the information is saved in a listing profile data file stored on server 104 or 106. The listing profile data file includes the data entered by the user as well as codes for formatting the data into a webpage as described hereinafter. The information is formatted into the finished listing profile in any of a variety of desirable presentation formats in a known manner using XML (extensible markup language) and/or XSL (extensible style sheet language). Other markup languages are contemplated. The finished listing profile is a formatted software presentation including all relevant aspects relating to the real estate as determined by the user's input.

The listing profile data file is saved on server 104 and designated with a unique uniform resource locator (URL) that can be accessed and viewed from a remote computing device such as computer 108 over a network such as the Internet as would be appreciated by those of skill in the art. When accessed by a user, the server 104 or 106 (which may also be webservers) process the request. Alternatively, the request may be received for processing by a separate webserver to which servers 104 or 106 are networked. In response to a request, the data file or files are accessed and forwarded to the user. The listing profile data file is formatted by the user's browser as is known in the art so that the user is presented with the formatted listing profile.

During and/or after setup of the listing profile, the URL where the listing profile data file is stored may be accessed and viewed from a variety of the above-described screens, such as for example setup screen 120 at URL 300 (FIGS. 4 and 20). It is understood that the listing profile may be updated in real time; that is, as the information is added and saved using the above-described screens. In such embodiments, the listing profile at URL 300 may be viewed at any stage of its completion. Alternatively, the information may be stored in an intermediate file, and then uploaded to the memory location addressed by the URL when listing profile is completed.

The listing profile data file may be viewed by accessing the URL 300. It is understood that the data making up a listing profile may in fact be stored in more than one data file, two or more of them being presented in the listing profile upon accessing the URL 300.

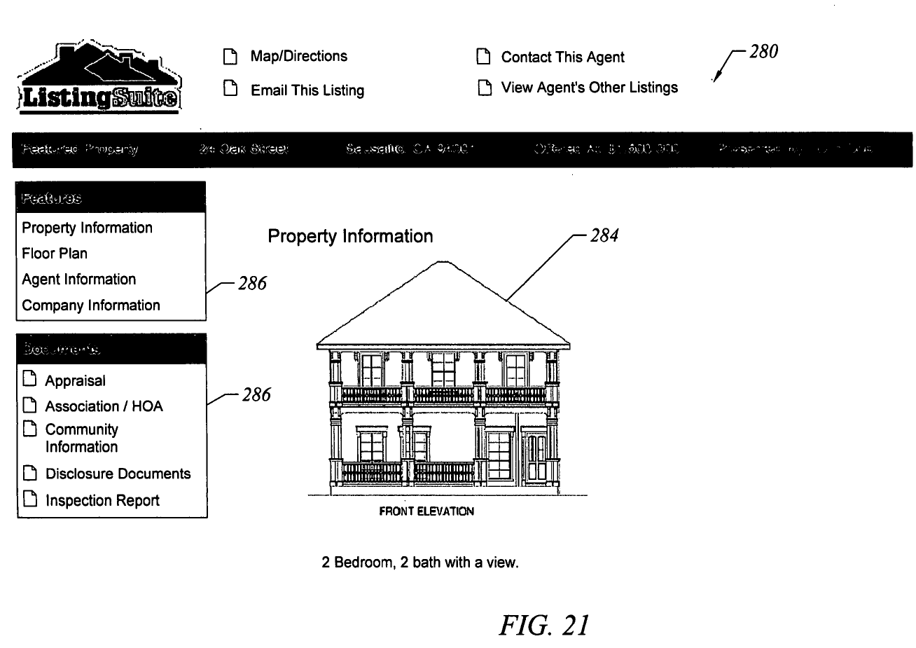

FIG. 21 shows an example of a page 280 of a listing profile created using the various templates shown in FIGS. 4 through 20. In embodiments of the invention, the listing profile may be opened in conventional browsers, such as for example, Internet Explorer and Netscape Navigator, and includes all of the information added by the user via the templates shown in FIGS. 4 through 20. As shown in FIG. 21, the first page of the listing profile may show the property to be sold in the picture 284, which may be added in screen 130 (FIG. 3) as described above. The screen 280 may include one or more menus 286 with hyperlinks for all the information added by the user relating to the property. The menu items included correspond to the items selected on the template shown in setup screen 120 of FIG. 4. Upon accessing a hyperlink, the information and/or documents added as described above are presented to the user. As previously indicated, where the user is a listing agent, the listing profile may be stored on a server 104 (FIG. 1) accessible by the listing agent and other agents within the listing agent's organization. Many real estate brokerage organizations are large companies with a large number of agents in different geographical locations. By storing the listing profile on the agent's server 104, the listing profile may be administered to by a single administrator while being accessible to many agents in many different geographic locations. Where the user is the seller of the real estate, the listing profile may alternatively or additionally be stored on a server 106 to which the user of the present invention subscribes, and which may be accessed over the Internet by viewers at large or by those authorized as by user id and password to view the listing profile.

Information Management

As indicated in the Background of the Invention section, real estate transactions often take several months to complete and the information related to the transaction may often change. Referring again to the main option screen 110 in FIG. 2, a user is given the ability to work with a previously saved listing profile to update or otherwise edit information presented on the listing profile. Thus, the software according to the present invention provides an easy, efficient and immediate method for managing real estate transactions and for keeping information relating to a piece of real estate current.

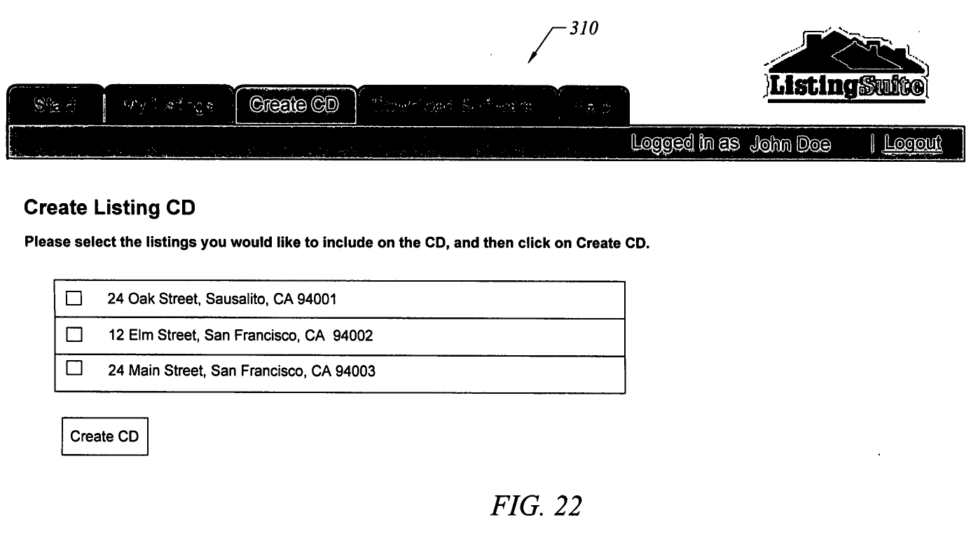

Before or after a listing profile according to the present invention is created, the main option screen 110 in FIG. 2 further provides the user with the ability to copy the listing profile onto a portable recording medium such as a compact disk (CD), floppy disc, or other recording medium. The software also provides the ability to print a CD label for a listing profile copied onto a CD. The software according to the present invention may present a screen 310 as shown in FIG. 22 for this purpose. In such embodiments, the software according to the present invention may link to a conventional software application (or customized version thereof) for generating and printing CD labels.

Information Dissemination

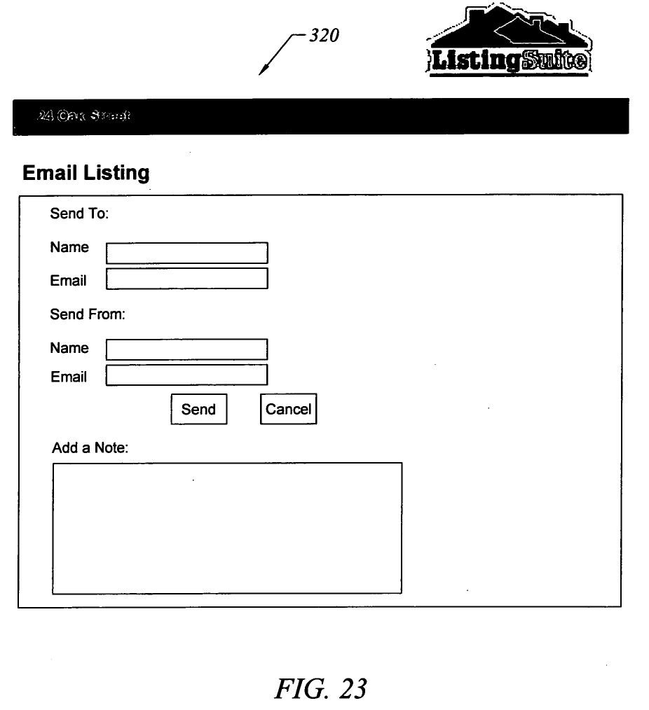

When a listing profile is saved, for example to server 104, it may also be assigned a URL address to allow the listing profile to be accessed from the server 104 via the World Wide Web as described above. Access may be fully provided or access may be restricted so that a user name and password is required before access to the listing profile is granted. The present invention further provides the ability to email a listing profile over a network using known email software applications such as Microsoft Outlook. The software according to the present invention may present a screen 320 as shown in FIG. 23 for this purpose. In embodiments of the present invention, the listing profile may be compressed prior to emailing software compression algorithms such as those resulting in zip files to reduce the size of the emailed file.

It is a further advantage that the information that the listing profile may be burned onto a portable medium such as a compact disc as described above, and the user and prospective purchasers may then print information and/or documents from the listing profile as desired. Thus, for example, if the user needs to print out graphics such as the floor plan and a flyer, this may be easily accomplished from the listing profile. It is understood that printing of selected information and documents may be accomplished from a listing profile stored on a portable medium or on a server.

It is a still further advantage of the present invention to greatly reduce the volumes of paper that are conventionally generated in relation to the sale of real estate. All information relating to a real estate transaction may be stored in the listing profile which, in addition to being comprehensive, may be quickly and easily updated. Thus, unlike paper records which are difficult to update once given out to prospective buyers or finance companies, when prospective buyers and finance companies access the information on the listing profile, it will always be current. Furthermore, with paper transactions, a significant amount of physical space is required to store completed and past transactions. The present invention frees up all of this space by allowing electronic storage of completed and past transactions.

Although the present invention has been described thus far as relating to the assembling, organizing, disseminating and managing of information relating to real estate transactions, it is to be understood that the present invention may be used in fields unrelated to real estate. For example, the software according to the present invention may be used in the legal field. In such an embodiment, the software may present the user with the option to select a variety of templates for entering a variety of information and/or documents relating to a particular litigation or a particular matter, thereafter generating a disc where all relevant information may be easily and coherently viewed using a browser from the user's own computer or over a network such as a LAN or the Internet. The present invention may also be adapted for use in the insurance industry, allowing the user to enter a variety of information relating to various claims, and then presenting the information in a disc. It is also contemplated that the present invention be used in the medical field for keeping track of patient information. The present invention may be used in a variety of additional fields such as, for example, personal training and physical therapy, entertainment and sports.

Although the invention has been described in detail herein, it should be understood that the invention is not limited to the embodiments herein disclosed. Various changes, substitutions and modifications may be made thereto by those skilled in the art without departing from the spirit or scope of the invention as described and defined by the claims to be added hereinafter.

1. A method of creating a presentation relating to real estate, comprising the steps of:
(a) gathering information relating to real estate using a graphical user interface;
(b) providing formatting instructions for formatting the information gathered in said step (a) into a presentation format; and
(c) saving the information at location on a computer memory accessible from a remote location via a network-attached computing device.

2. A method of creating a presentation relating to real estate as recited in claim 1, further comprising the step of displaying the information formatted in said step (b) on a display screen.

3. A method of creating a presentation relating to real estate as recited in claim 1, further comprising the step of automatically generating a unique universal address locator at which the information may be viewed after said step (c) of saving the information.

4. A method of creating a presentation relating to real estate as recited in claim 2, said step of displaying the information formatted in said step (b) on a display screen comprising the step of presenting a first webpage including a first portion of the information relating to real estate, and the first webpage including at least one link to at least a second webpage having a second portion of the information relating to real estate.

5. A method of creating a presentation relating to real estate as recited in claim 1, said step (a) of gathering information relating to real estate comprising the step of gathering information relating to at least one of: i) a description of a real estate property, ii) a listing agent for a real estate property, iii) a slide show showing a real estate property, iv) a virtual tour showing a real estate property, v) a floor plan for a property, and vi) a flyer for a real estate property.

6. A method of creating a presentation relating to real estate as recited in claim 1, said step (a) of gathering information relating to real estate comprising the step of gathering information relating to at least one of: i) a title report for a real estate property, ii) an inspection report for a real estate property, iii) an appraisal for a real estate property, iv) a disclosure document for a real estate property, v) a sale and escrow document for a real estate property, vi) information relating to a community in which a real estate property is located, and vii) home owner association dues for a real estate property.

7. A method of creating a presentation relating to real estate as recited in claim 1, said step (b) of formatting the information gathered in said step (a) into a presentation format comprises the step of formatting the information for presentation on one or more webpages.

8. A method of creating a presentation relating to real estate as recited in claim 1, said step (b) of formatting the information gathered in said step (a) into a presentation format comprises the step of formatting the information using extensible markup language.

9. A method of creating a presentation relating to real estate as recited in claim 1, further comprising the step of copying the information formatted in said step (b) onto a portable recording medium.

10. A method of creating a presentation relating to real estate as recited in claim 1, further comprising the step of emailing the information formatted in said step (b) to a recipient.

11. A method of creating a presentation relating to real estate, comprising the steps of:
(a) presenting a user with a graphical user interface allowing the user to enter one or more pieces of information relating to real estate;
(b) entering one or more pieces of information relating to real estate via the graphical user interface presented to the user in said step (a);
(c) providing formatting instructions for formatting the information entered in said step (b) for presentation on one or more webpages; and
(d) saving the information at location on a computer memory accessible from a remote location via a network-attached computing device.

12. A method of creating a presentation relating to real estate as recited in claim 11, further comprising the step of displaying the information formatted in said step (c) on a display screen.

13. A method of creating a presentation relating to real estate as recited in claim 11, further comprising the step of automatically generating a unique universal address locator at which the information may be viewed after said step (d) of saving the information.

14. A method of creating a presentation relating to real estate as recited in claim 12, said step of displaying the information formatted in said step (c) on a display screen comprising the step of presenting a first webpage including a first piece of the one or more pieces information relating to real estate, and the first webpage including at least one link to at least a second webpage having a second piece of the one or more pieces of information relating to real estate.

15. A method of creating a presentation relating to real estate as recited in claim 11, said step (a) presenting a user with a graphical user interface allowing the user to enter one or more pieces of information relating to real estate comprising the step of allowing the user to enter one or more of the following pieces of information: i) a description of a real estate property, ii) a listing agent for a real estate property, iii) a slide show showing a real estate property, iv) a virtual tour showing a real estate property, v) a floor plan for a property, and vi) a flyer for a real estate property.

16. A method of creating a presentation relating to real estate as recited in claim 11, said step (a) presenting a user with a graphical user interface allowing the user to enter one or more pieces of information relating to real estate comprising the step of allowing the user to enter one or more of the following pieces of information: i) a title report for a real estate property, ii) an inspection report for a real estate property, iii) an appraisal for a real estate property, iv) a disclosure document for a real estate property, v) a sale and escrow document for a real estate property, vi) information relating to a community in which a real estate property is located, and vii) home owner association dues for a real estate property.

17. A method of creating a presentation relating to real estate as recited in claim 11, further comprising the step of copying the information formatted in said step (c) onto a portable recording medium.

18. A method of creating a presentation relating to real estate as recited in claim 11, further comprising the step of emailing the information formatted in said step (c) to a recipient.

19. One or more processor readable storage devices having processor readable code embodied on said one or more processor readable storage devices, said processor readable code for programming one or more processors to perform a method comprising the steps of:
(a) gathering information relating to real estate using a graphical user interface;
(b) providing formatting instructions for formatting the information gathered in said step (a) into a presentation format; and
(c) saving the information at location on a computer memory accessible from a remote location via a network-attached computing device.

20. A method of creating a presentation relating to real estate as recited in claim 19, further comprising the step of displaying the information formatted in said step (b) on a display screen.

21. A method of creating a presentation relating to real estate as recited in claim 20, said step of displaying the information formatted in said step (b) on a display screen comprising the step of presenting a first webpage including a first piece of the one or more pieces information relating to real estate, and the first webpage including at least one link to at least a second webpage having a second piece of the one or more pieces of information relating to real estate.

22. One or more processor readable storage devices having processor readable code embodied on said one or more processor readable storage devices, said processor readable code for programming one or more processors to perform a method comprising the step of:
(a) presenting on a display a listing profile relating to real estate, information in the listing profile acquired via a graphical user interface configured to prompt a user to input the information relating to the real estate, and the listing profile formatted for presentation over a webpage.
